(19) United States
(12) Patent Application Publication
(10) Pub. No.: US 2025/0104507 A1
(43) Pub. Date: Mar. 27, 2025

(54) GAMING MACHINE, METHOD FOR PROVIDING GAME, AND PROGRAM

(71) Applicant: Konami Gaming, Inc., Las Vegas, NV (US)

(72) Inventor: Masaya MATSUDA, Zama-shi (JP)

(21) Appl. No.: 18/895,373

(22) Filed: Sep. 24, 2024

(30) Foreign Application Priority Data
Sep. 26, 2023 (JP) 2023-162901

(51) Int. Cl. G07F 17/32

(52) U.S. Cl. CPC G07F 17/3213; G07F 17/3267

(57) ABSTRACT

A gaming machine is described herein. The gaming machine includes a control unit that spins and stops a plurality of reels in response to an operation performed by a player, wherein the control unit sequentially stops the reels after spinning of the reels has been started, adds, when special symbols displayed in a column formed by a reel that has already stopped and a column formed by a newly stopped reel in the display area form a winning combination, a randomly determined number of special symbols is added to the column formed by the newly stopped reel in the display area before stopping the next reel, and awards a prize for the arrangement of the special symbols displayed after all the reels have been stopped.

### CROSS REFERENCE TO RELATED APPLICATION

This application claims priority to Japanese Patent Application No. 2023-162901, filed Sep. 26, 2023, the disclosure of which is hereby incorporated by reference in its entirety.

### TECHNICAL FIELD

The present disclosure relates to a gaming machine, a method for providing a game, and a program.

### BACKGROUND OF THE INVENTION

Patent Document 1 discloses a gaming machine that expands the positions in which symbols are displayed. This gaming machine has a function that expands the symbol display positions and increases the number of displayed symbols based on what is displayed in the symbol display area when the spinning reels have been stopped. Patent Document 1 also discloses a function for generating trigger events based on random numbers, player selections, bet amounts, symbols, play time, play rates, etc., and increasing the number of displayed symbols in response to the occurrence of trigger events.
Patent Document 1: U.S. Pat. No. 9,483,900 B2.

### SUMMARY OF THE INVENTION

The gaming machine in Patent Document 1 displays new symbols by expanding the symbol display positions, but does not award new prizes according to the types of symbols already displayed and new symbols that are displayed. For this reason, players do not have high expectations regarding a function that expands the symbol display positions, and if no new prizes are awarded when this function is activated during play, player interest in the game may wane.

It is an object of the present disclosure to provide a gaming machine, method for providing a game, and a program that includes a function that can provide new and exciting experiences that keep players interested and increase their expectations.

An aspect of the present disclosure is a gaming machine comprising: a control panel that accepts player operations; a display unit having a display area that partially displays a plurality of reels each having symbols, the symbols including special symbols; and a control unit connected to the control panel and the display unit that spins and stops the plurality of reels in response to the player operating the control panel, and awards a prize when the displayed symbols form a winning combination over a predetermined number of columns of symbols among the stopped reels in the display area, wherein the control unit sequentially stops the reels after spinning of the reels has been started, adds, when special symbols displayed in a column formed by a reel that has already stopped and a column formed by a newly stopped reel in the display area form a winning combination, a randomly determined number of special symbols is added to the column formed by the newly stopped reel in the display area before stopping the next reel, and awards a prize for the arrangement of the special symbols displayed after all the reels have been stopped.

Another aspect of the present invention is a method for providing a game executed by a gaming machine comprising: a control panel that accepts player operations; a display unit having a display area that partially displays a plurality of reels each having symbols, the symbols including special symbols; and a control unit connected to the control panel and the display unit that spins and stops the plurality of reels in response to the player operating the control panel, and awards a prize when the displayed symbols form a winning combination over a predetermined number of columns of symbols among the stopped reels in the display area, wherein the control unit executes the steps of: sequentially stopping the reels after spinning of the reels has been started; adding, when special symbols displayed in a column formed by a reel that has already stopped and a column formed by a newly stopped reel in the display area form a winning combination, a randomly determined number of special symbols is added to the column formed by the newly stopped reel in the display area before stopping the next reel; and awarding a prize for the arrangement of the special symbols displayed after all the reels have been stopped.

Still another aspect of the present invention is a program executed by a control unit in a gaming machine comprising: a control panel that accepts player operations; a display unit having a display area that partially displays a plurality of reels each having symbols, the symbols including special symbols; and a control unit connected to the control panel and the display unit that spins and stops the plurality of reels in response to the player operating the control panel, and awards a prize when the displayed symbols form a winning combination over a predetermined number of columns of symbols among the stopped reels in the display area, wherein the program executes in the control unit the functions of: sequentially stopping the reels after spinning of the reels has been started; adding, when special symbols displayed in a column formed by a reel that has already stopped and a column formed by a newly stopped reel in the display area form a winning combination, a randomly determined number of special symbols is added to the column formed by the newly stopped reel in the display area before stopping the next reel; and awarding a prize for the arrangement of the special symbols displayed after all the reels have been stopped.

In yet another aspect of the present invention, a gaming machine is provided. The gaming machine includes a control panel that accepts player operations, a display unit including a display screen displaying computer-generated images thereon, and a control unit operably coupled to the control panel and the display unit. The control unit including one or more processors programmed to execute an algorithm to display an animated sequence of computer-generated images on the display unit including the steps of: displaying a display area on the display screen that partially displays a plurality of reels each having symbols, the symbols including special symbols; spinning the plurality of reels in response to the player operating the control panel; sequentially stopping the reels after spinning of the reels has been started; and adding, when special symbols displayed in a column formed by a reel that has already stopped and a column formed by a newly stopped reel in the display area form a winning combination, a randomly determined number of additional special symbols to the column formed by the newly stopped reel in the display area before stopping the next reel.

In yet another aspect of the present invention, a method of operating a gaming machine is provided. The gaming machine includes a control panel that accepts player operations, a display unit including a display screen displaying computer-generated images thereon, and a control unit including one or more processors operably coupled to the control panel and the display unit. The method includes the one or more processors performing an algorithm to display an animated sequence of computer-generated images on the display screen including the steps of: displaying a display area on the display screen that partially displays a plurality of reels each having symbols, the symbols including special symbols; spinning the plurality of reels in response to the player operating the control panel; sequentially stopping the reels after spinning of the reels has been started; and adding, when special symbols displayed in a column formed by a reel that has already stopped and a column formed by a newly stopped reel in the display area form a winning combination, a randomly determined number of additional special symbols to the column formed by the newly stopped reel in the display area before stopping the next reel.

In yet another aspect of the present invention, non-transitory computer-readable storage media having computer-executable instructions embodied thereon to operate a gaming machine is provided. The gaming machine includes a control panel that accepts player operations, a display unit including a display screen displaying computer-generated images thereon, and a control unit including one or more processors operably coupled to the control panel and the display unit. When executed by the one or more processors the computer-executable instructions cause the one or more processors to perform an algorithm to render an animated sequence of computer-generated images on the display screen including the steps of: displaying a display area on the display screen that partially displays a plurality of reels each having symbols, the symbols including special symbols; spinning the plurality of reels in response to the player operating the control panel; sequentially stopping the reels after spinning of the reels has been started; and adding, when special symbols displayed in a column formed by a reel that has already stopped and a column formed by a newly stopped reel in the display area form a winning combination, a randomly determined number of additional special symbols to the column formed by the newly stopped reel in the display area before stopping the next reel.

The present disclosure adds a randomly determined number of special symbols to the last column when columns formed in the display area by previously stopped reels and the column formed in the display area by a newly stopped reel form a winning combination. Here, the symbol display positions may be extended depending on the number of symbols to be added. Because symbols of the same type that already make up a winning combination are added, the present disclosure is able to provide a gaming machine, method for providing a game, and a program that increases players' hopes of winning new prizes or increasing the number of prizes they can win, and that can provide new and exciting experiences that keep players interested and raise their expectations.

### BRIEF DESCRIPTION OF DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a perspective view showing an example of a gaming machine in an embodiment of the present disclosure;

FIG. 2 is a block diagram showing an example of the configuration of the gaming machine in FIG. 1;

FIG. 3 is a simplified diagram of the display area in the gaming machine shown in FIG. 1;

FIG. 4 shows an example of a virtual reel set;

FIG. 5 shows examples of symbols;

FIGS. 6-15 shows an example of the animated sequences of computer-generated images of game screens illustrating an algorithm for displaying a feature game on the gaming machine shown in FIG. 1, according to an embodiment of the present invention;

FIGS. 16-18 shows an example of the animated sequences of computer-generated images of game screens illustrating an algorithm for displaying a re-spin feature on the gaming machine shown in FIG. 1, according to an embodiment of the present invention;

FIG. 19 is a directory structure diagram and block diagram showing a program and data stored in the memory in FIG. 2;

FIG. 20 is a block diagram of a system for a gaming machine;

FIG. 21 is a block diagram of the game application program in FIG. 20;

FIG. 22 is a block diagram of the system application program in FIG. 20; and

FIGS. 23-24 are flow charts illustrating algorithms used during operation of the gaming machine to generate and display animated sequences of computer-generated images shown in FIGS. 6-18 to display the feature game and re-spin feature on the gaming machine shown in FIG. 1, according to one embodiment of the present invention.

Corresponding reference characters indicate corresponding parts throughout the drawings.

### DETAILED DESCRIPTION OF THE INVENTION

A gaming machine in an embodiment of the disclosure will now be described with reference to the appended drawings. The same or equivalent elements in each drawing are denoted by the same reference numbers, and redundant descriptions of these elements have been omitted.

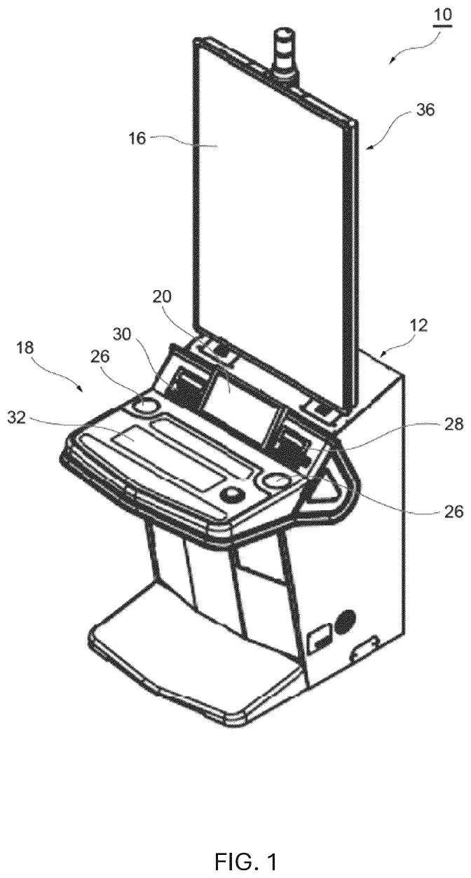

FIG. 1 is a perspective view showing an example of a gaming machine in an embodiment of the present disclosure. A gaming machine is a device that accepts wagers from players, such as banknote, medallions, and tokens to start a game, and then pays out winnings, prizes, and payouts to players according to randomly determined game results. Gaming machines are designed and manufactured in accordance with local regulations, and are installed in licensed facilities such as casinos after being approved by an authorizing organization as an authorized device. The gaming machine 10 shown in FIG. 1 can accept a predetermined game price from a player, generate a game result, and provide a payout to the player according to the game result and a payout table. A gaming machine 10 can provide, for example, a video slot game. Video slot games include regular games, free games, and feature games. Regular games, free games, and feature games are provided when predetermined conditions are met. In regular games, free games and feature games, symbols displayed in a display area make up symbol combinations that are the game results, and these combinations are used to determine prizes.

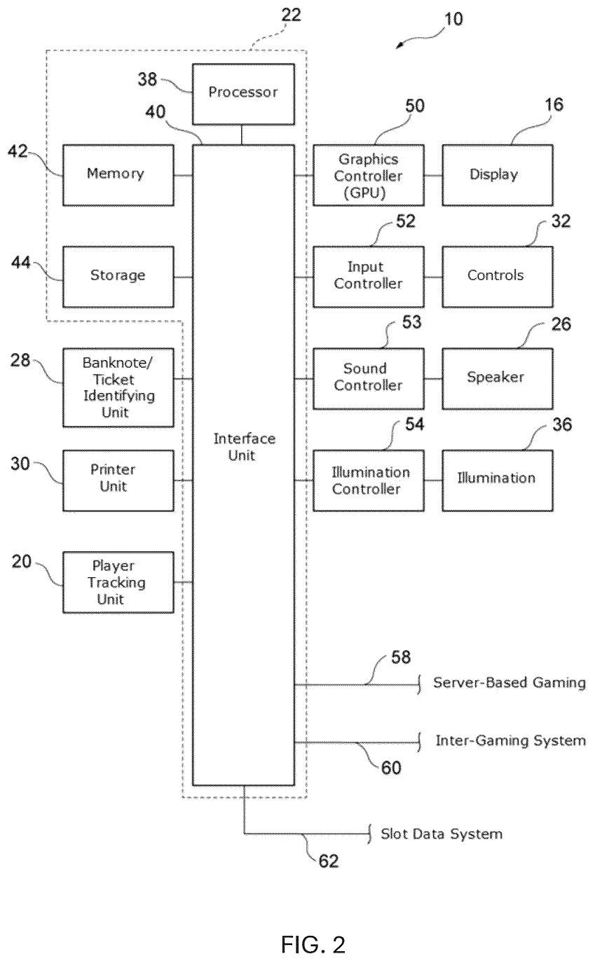

As shown in FIG. 1, the gaming machine 10 has a display 16 (an example of a display unit) and a cabinet 12. The cabinet 12 also contains a control unit 22 (see FIG. 2) that controls the components in the gaming machine 10.

The display 16 is a flat panel display device such as an LCD or OLED display device. The display 16 presents a game screen to the player controlled by the control unit 22. Illumination 36 may be installed around display 16 to provide decorative lighting.

The cabinet 12 is located below the display 16. The cabinet 12 has a control panel 18 that protrudes forward from the front of the cabinet. The control panel 18 is provided with a player tracking unit 20, speakers 26, a banknote/ticket identifying unit 28, a printer unit 30, and controls 32.

The player tracking unit 20 includes a card reader that recognizes player identification cards, a display that presents data to players, and a keypad that accepts player input. The player tracking unit 20 working in tandem with the control unit 22 or an external system reads information recorded on a player identification card inserted into the card reader by a player, and displays this information and or information obtained via communication with an external system on the display. Keypad input from the player is also accepted, the display is changed according to the input, and communication with an external system is performed as necessary.

Speakers 26 are provided on the left and right of the control panel 18. The speakers 26 are controlled by the control unit 22 to provide sound for the player.

The banknote/ticket identifying unit 28 can be housed in the cabinet 12 with an exposed insertion slot for inserting banknotes or tickets. There is a sensor inside the slot to identify banknotes and tickets. A banknote/ticket storage unit is provided on the output end of the identifying unit. The banknote/ticket identifying unit 28 accepts banknotes or tickets (including vouchers and coupons) with game value, identifies them as having a certain game value, and notifies the control unit 22.

A printer unit 30 can be housed inside the cabinet 12 with an exposed ticket discharge slot for discharging tickets. A printing unit for printing specific information on a slip of paper inside the ticket discharge slot. A storage unit that holds the paper is provided on the paper input end of the printing unit. The printer unit 30 prints information on paper under the control of the control unit 22, and outputs tickets from the gaming machine 10 according to a credit payout process. A ticket that has been outputted can be inserted into the banknote/ticket identifying unit 28 of another gaming machine to use paid-out credits for game play, or it can be exchanged for cash at a kiosk terminal or casino cage in the casino.

The controls 32 are used to accept player input. The controls 32 include a group of buttons used to accept various instructions from a player in front of the gaming machine 10. For example, the controls 32 may include a group of spinning buttons and setting buttons. The spinning buttons accept instructions to start a game session (start the reels spinning). The group of setting buttons includes, for example, bet-placing buttons and a cash-out button. The group of betting buttons are used to accept instructions from the player regarding the amount of credit to be bet (bet amount). The cash-out button is used to accept an instruction to cash out credits accumulated in the gaming machine 10.

FIG. 2 is a block diagram showing an example of a configuration for a gaming machine. The gaming machine 10 includes a control unit 22. The control unit 22 includes a CPU (Central Processing Unit) 38, including one or more processors that constitutes the control unit 22, an interface unit 40, memory 42, and storage 44, etc. The control unit 22 can be housed inside the cabinet 12 as a control board. The control unit 22 is configured to be able to communicate with each component via an interface unit 40, and controls the operation of each component by executing a program recorded in the memory 42 (an example of a storage unit) or the storage 44 (an example of a storage unit) for the CPU 38 in order to provide the game to the player.

The interface unit 40 includes a chipset that provides the communication functions of the CPU 38, such as a memory bus connected to the CPU 38, expansion buses, a serial interface, a USB (Universal Serial Bus) interface, and an Ethernet (registered trademark) interface.

The memory 42 can be configured to include a volatile memory medium such as RAM (Random Access Memory), a non-volatile memory medium such as ROM (Read-Only Memory), and a rewritable non-volatile memory medium such as EEPROM (Electrically Erasable Programmable Read-Only Memory). The storage 44 provides the control unit 22 with the functions of an external storage device, and makes it possible to use removable storage media such as a memory card or optical disk, in addition to a hard disk.

The interface unit 40 is connected to the banknote/ticket identifying unit 28, the printer unit 30, the player tracking unit 20, a graphics controller (GPU: Graphics Processing Unit) 50, an input controller 52, a sound controller 53, and an illumination controller 54. The graphics controller 50, input controller 52, sound controller 53, and illumination controller 54 can be housed inside the cabinet 12 as a control board.

The control unit 22 is connected to the display 16 via the graphics controller 50. The control unit 22 is connected to the controls 32 via the input controller 52. The control unit 22 is connected to the illumination 36 via the illumination controller 54.

The control unit 22 controls each component by executing a program stored in the memory 42 and the storage 44 to provide the game to the player. For example, here, the operating system, subsystem programs, and data that provide the basic functions of the control unit 22 may be stored in EEPROM inside the memory 42, and the program and application data that provide the game may be stored in the storage 44. By using this configuration, the game can be easily changed or updated by replacing the storage 44. The control unit 22 may also be configured with a multiprocessor configuration including a plurality of CPUs.

Each block connected to the control unit 22 will now be described. The banknote/ticket identifying unit 28 accepts a banknote or ticket at the insertion slot and notifies the control unit 22 of identifying information corresponding to the type of banknote or credit payout process. The control unit 22 increases the amount of credit available in the game based on the details. The printer unit 30 accepts activation of the cash-out button in the control unit 32, and prints information corresponding to the credit payout process from the gaming machine 10 under the control of the control unit 22 on a ticket, which is then outputted.

The player tracking unit 20 operates in tandem with the control unit 22 to exchange player information and other information with the casino management system. The graphics controller 50, under the control of the control unit 22, displays images containing various graphics data on the display 16. The sound controller 53 drives the speakers 26 under the control of control unit 22 to provide various sounds such as announcements, sound effects, and background music. The illumination controller 54 performs lighting control of the illumination 36 under the control of control unit 22.

The interface unit 40 includes various communication interfaces for communicating with devices outside of the gaming machine 10. The interface unit 40 can communicate with external networks, for example, by means of Ethernet 55, 58, 60, and a serial interface 62. Examples of communication with other gaming machines 10 using a known server-end gaming network (server-based gaming), G2S network (game-to-system), and slot information system (slot data system) are shown in FIG. 2. The control unit 22 can share information about games with other gaming machines 10 by communicating with the control unit 22 in other gaming machines 10 via Ethernet 55, 58, 60 without an I/O board.

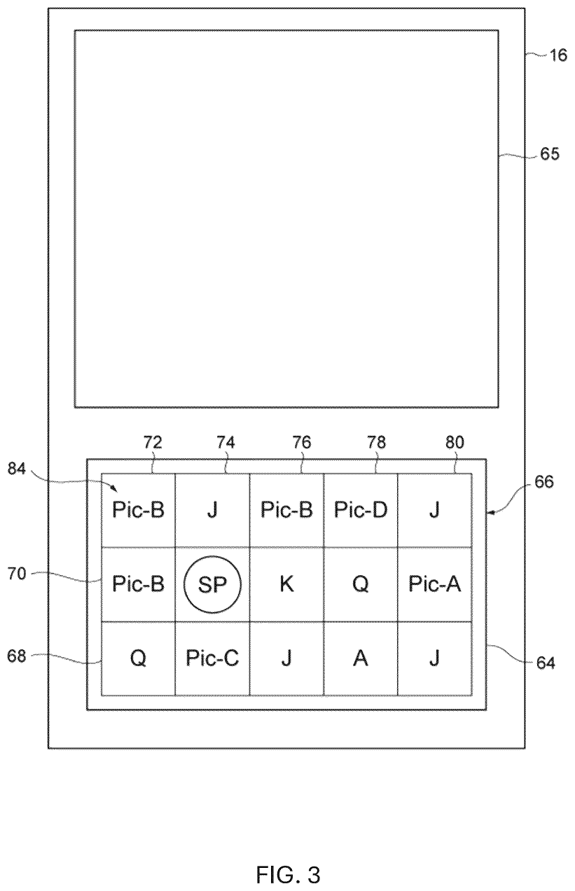

FIG. 3 is a simplified diagram of the display area in the gaming machine shown in FIG. 1. As shown in FIG. 3, a game screen is displayed in the display area of the display 16 by the control unit 22 executing a predetermined program. The game screen has a symbol display area 64 showing a slot game. The symbol display area 64 can be displayed, for example, in the lower area of the game screen. An area 65 is provided above the symbol display area 64 for displaying game-related information and other information.

The symbol display area 64 includes a grid 68 on which symbols can be displayed. By using such a display area, a gaming machine 10 can operate as a slot machine that determines prizes and pays out prizes according to the combinations of symbols displayed on the grid 68 in symbol display region 64.

The display 16 displays a plurality of symbols in the grid 68. The grid 68 contains a plurality of rows and columns. The grid 68 is composed of a plurality of cells 70, which are the stopping positions of the symbols. FIG. 3 shows a game screen containing a plurality of cells arranged in a 5×3 grid. The number of columns and rows in the grid is not limited, and other configurations may be used, such as 5×4, 3-4-4-4-3, 6×3, 6×4, and 3-3-3-5-5, etc. In addition, the configuration increases or decreases the grid depending on the game progress and/or the bet amount. Each cell 70 in the symbol display area 64 displays a stopped symbol.

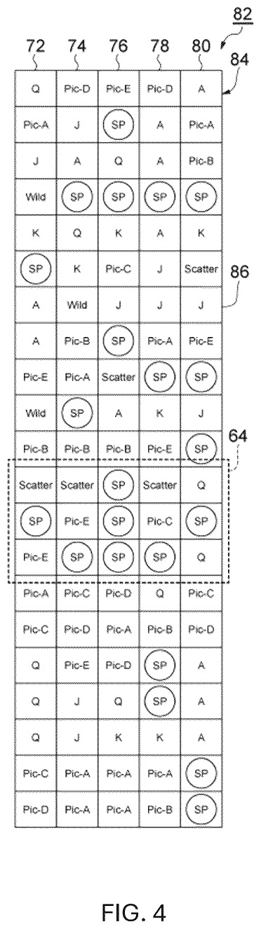

The symbols arranged in each of the cells 70 are determined by virtual reel strips displaying virtual reels 66. FIG. 4 shows an example of a virtual reel set. The virtual reel set includes a plurality of virtual reel strips, and virtual reel strips include an arrangement of symbols that indicates the order of the symbols displayed in the display area. In each cell 70 of the grid 68 shown in FIG. 3, symbols are displayed based on the arrangement of symbols on the virtual reels 66, which include virtual reel strips 72, 74, 76, 78, and 80 that make up the virtual reel set 82. In other words, the cells 70 in grid 68 correspond to virtual reel strips 72 to 80 in each column, and the symbols arranged in certain portions of virtual reel strips 72 to 80 are displayed. The symbols displayed in the cells 70 of the grid 68 are changed by moving (scrolling or spinning) the symbols in each column based on the arrangement of symbols on virtual reel strip 72 to 80, and the symbols are stopped by stopping the movement (scrolling or spinning) in each column. Here, virtual reel strips 72 to 80 consist of data, and the control unit 22 uses a program in the memory 42 or storage 44 and this data to display the arrangement of symbols (that is, the order of the symbols on each reel strip) adjusted in each cell column. Virtual reel set 82 is a collective term for the virtual reel strips 72-80.

The virtual reel strips 72-80 shown in FIG. 4 are composed of symbols 84 at each symbol position 86, and these symbols are arranged in the order defined for each reel. The number of symbols constituting the virtual reel strips 72-80 is not limited, and can be any number desired. In addition, the number of symbols that constitute each of virtual reel strips 72 to 80 may be the same or different.

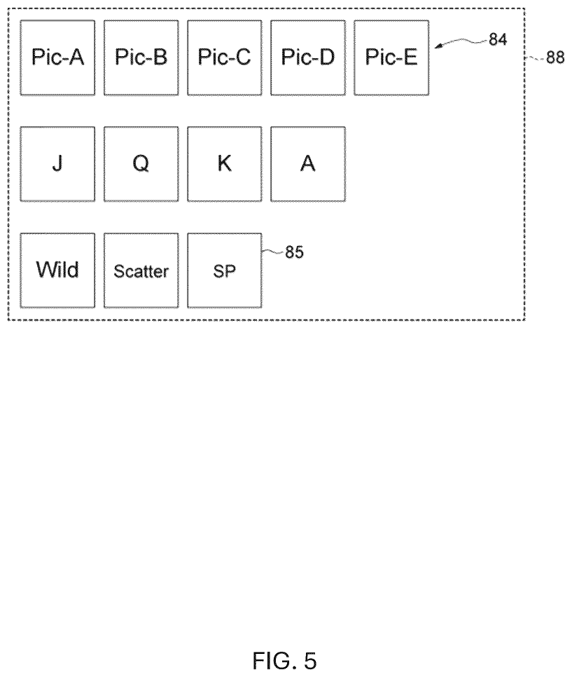

FIG. 5 is used to explain details of the symbols 84 shown in FIG. 4. Each virtual reel strip 72-80 contains symbols selected from the set 88 of symbols 84 shown in FIG. 5. The symbol set 88 includes the standard symbols: card symbols (J, Q, K, and A) that resemble playing cards, as well as picture symbols (Pic-A, Pic-B, Pic-C, Pic-D, and Pic-E) that indicate pictures of people, animals, plants, objects, and treasures, etc.

The symbol set 88 also includes a special symbol 85 (“SP”). The special symbol 85 is a symbol to which a feature is applied in the feature game described below. The special symbol may be a symbol selected from among the standard symbols. For example, the special symbol 85 can be “Pic-A” or “Pic-B”. The symbol set 88 may include a wild symbol (“Wild”) that is substituted for another symbol when determining a winning combination, and a scatter symbol (“Scatter”) that triggers a free game when a predetermined number appears when determining a winning combination.

A plurality of virtual reel sets may be prepared that are game content-dependent. For example, the virtual reel set used in a regular game can be separate from the virtual reel set used in a free game. The virtual reel set for the free game may include more picture symbols, wild symbols, or special symbols 85 than the virtual reel set for the regular game. In this way, the probability of winning in or the expected value of a free game can be increased to provide players with a high-value free game.

The control unit 22 starts a game and randomly determines the stopping positions of each virtual reel strip 72-80. The virtual reel strips 72-80 displayed on the display 16 start moving (scrolling or spinning) from the current position, stop based on the stop positions, and indicate the result of the game. As a result, in the display 16 or grid 68, the symbols on the virtual reel strips 72-80 change with the continuous vertical movement (scrolling or spinning) of the virtual reel strips 72-80 in the symbol display area 64, and symbols stop in each cell 70 according to the order of the symbols specified on the virtual reel strips 72-80.

The control unit can be configured so that the symbols displayed on the display 16 change according to the method described above, according to a player operation accepted using the controls 32, the symbols are stopped in a predetermined order, and a payout is made according to the symbols that have stopped in the symbol display area 64.

The gaming machine 10 in the present embodiment, for example, determines the prize according to so-called all-ways-win (ALL-WAYS-WIN). The control unit 22 determines that the same symbol appearing in a plurality of consecutive columns from the leftmost column displayed on the display 16 is a winning combination. In other words, when the cells are arranged in a 5×3 grid as shown in FIG. 3, there are 3×3×3×3×3=253 possible winning combinations. The payout table defines the prize amounts according to the type and number of symbols that make up a valid combination. The control unit 22 determines that a win has occurred when a specified number of identical symbols appears in adjacent columns in the results of a game, which consists of a combination of symbols, and pays the player a payout according to the type and number of symbols.

The gaming machine 10 in the present embodiment provides three types of games: a regular game (also referred to as the main game or primary game) that is provided when predetermined conditions are not met, and a first special game and a second special game that are provided when predetermined conditions are met. The first special game is a feature game, and a feature function described below, which is advantageous to the player, is applied when the predetermined trigger conditions are met. The second special game is a free game, and a predetermined number of free games are provided that do not consume game tokens or credit when predetermined trigger conditions are met.

For example, the gaming machine 10 may include computer-executable instructions including algorithms for providing the Gong of Riches™ slot game series offered by Konami Gaming™ Inc.

In the regular game, the first special game, and the second special game described above, the symbols displayed in the symbol display area 64 are the only ones used to award a prize. In other words, the control unit 22 that has started a game randomly determines the stopping positions for each of the virtual reel strips 72-80 shown in FIG. 4, and uses the display 16 to represent the movement of the virtual reel strips 72-80 from their current positions to their stopping positions. This causes the symbols arranged on the virtual reel strips 72-80 to move (scroll) continuously in the vertical direction in the symbol display area 64 and then stop so that a single symbol appears in each cell 70 while maintaining a sense of continuity.

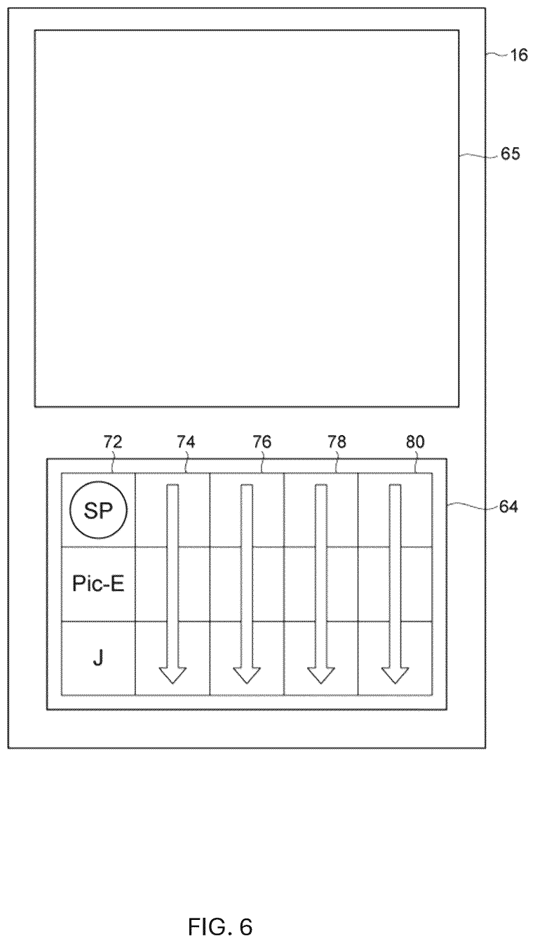

However, in the present embodiment, when spinning reels are stopped sequentially in a regular or free game, and special symbols 85 form a winning combination in the first column to stop and in subsequent columns to stop, the game immediately changes to a feature game, and the feature functions described below are applied. The feature function adds special symbols 85 to the columns that were once displayed in the symbol display area 64. Here, the manner in which the special symbols 85 are added is not limited to being added in the symbol display area 64. They can also be added so that they protrude (stick out) from the symbol display area 64. In other words, special symbols 85 can be added in addition to the number that can be added in the symbol display area 64. A game can also be designed to add a stack of special symbols above the displayed special symbols 85. When the feature function is applied, the special symbols 85 added outside the symbol display area 64 are also used to determine prizes. The feature functions are described below with reference to FIG. 6 to FIG. 18. In the following description, the reels displayed in the symbol display area 64 are referred to, from left to right, as the first reel, second reel, third reel, fourth reel, and fifth reel. The column formed by the first reel in the display area of the display 16 is referred to as the first column. Similarly, the column related to the second reel is referred to as the second column, the column related to the third reel as the third column, the column related to the fourth reel as the fourth column, and the column related to the fifth reel as the fifth column.

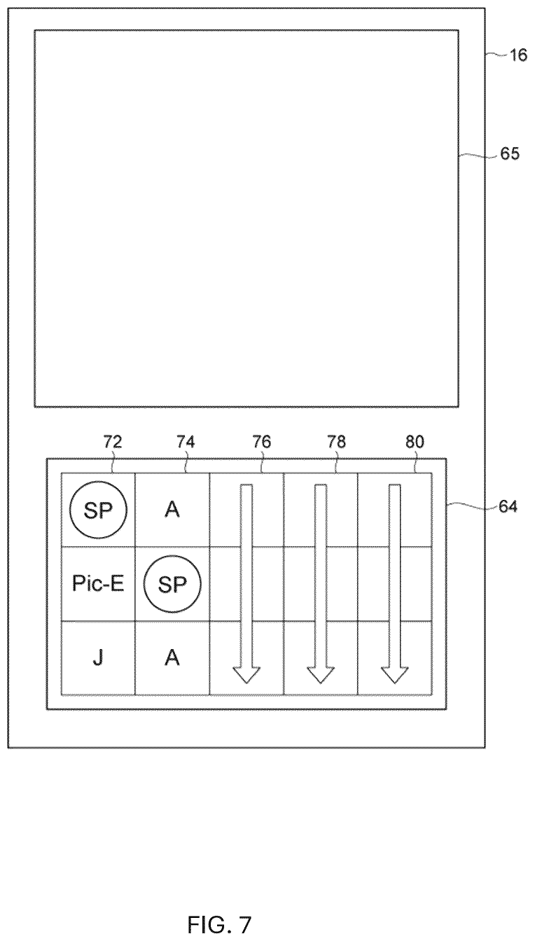

As shown in FIG. 6, the control unit 22 spins and sequentially stops the reels corresponding to virtual reel strips 72 to 80. In the example shown in FIG. 6, the control unit 22 stops the spinning first reel (virtual reel strip 72). The first column shows a special symbol 85, indicated here by “SP”. Then, the control unit 22, as shown in FIG. 7, stops the spinning second reel (virtual reel strip 74). In the example shown in FIG. 7, a special symbol 85 is displayed in the second column. Thus, adjacent special symbols 85 are displayed in both the first column in the display area of the display 16 for the first reel that had been stopped previously and the second column formed in the display area of the display 16 for the newly stopped second reel. Because the gaming machine in the present embodiment determines winnings using all-ways-win, these special symbols 85 make up a winning combination. In this case, the game moves to a feature game and a feature function is triggered.

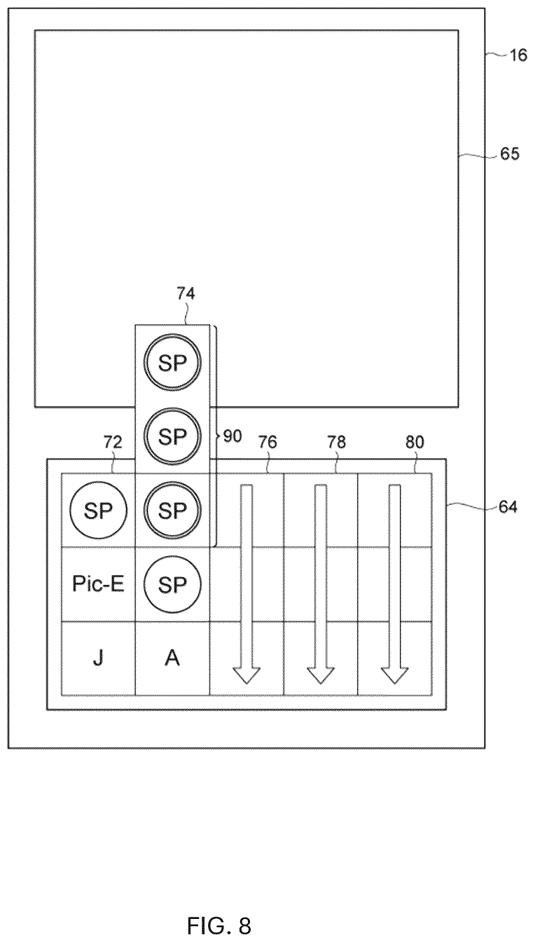

When the feature function is triggered, the control unit 22 adds a randomly determined number of special symbols 85 to the second column formed in the display area of display 16 for the newly stopped second reel before the third reel is stopped next. For example, as shown in FIG. 8, the control unit 22 determines that the number of special symbols 85 to be added will be three, for example, by drawing lots using random numbers. The control unit 22 then displays three additional special symbols 85 (additional symbols 90) above the special symbol 85 displayed in the second column before stopping the third reel. As shown in FIG. 8, when the second reel stopped, a special symbol 85 was displayed in the center cell of the three rows of the matrix. Therefore, two special symbols 85 are displayed among the additional symbols 90 outside of the symbol display area 64. In other words, the control unit 22 extends the second column upward by two cells and displays two special symbols 85 outside of the symbol display area 64.

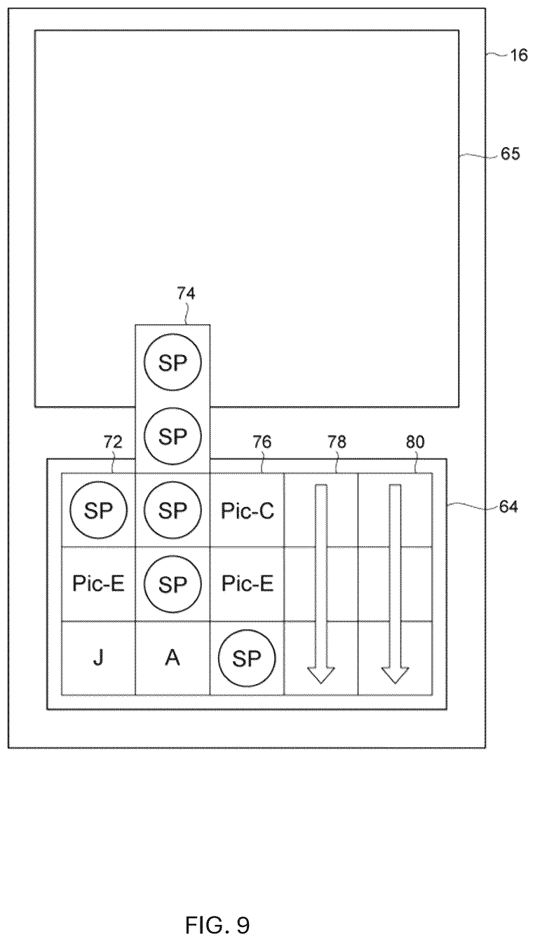

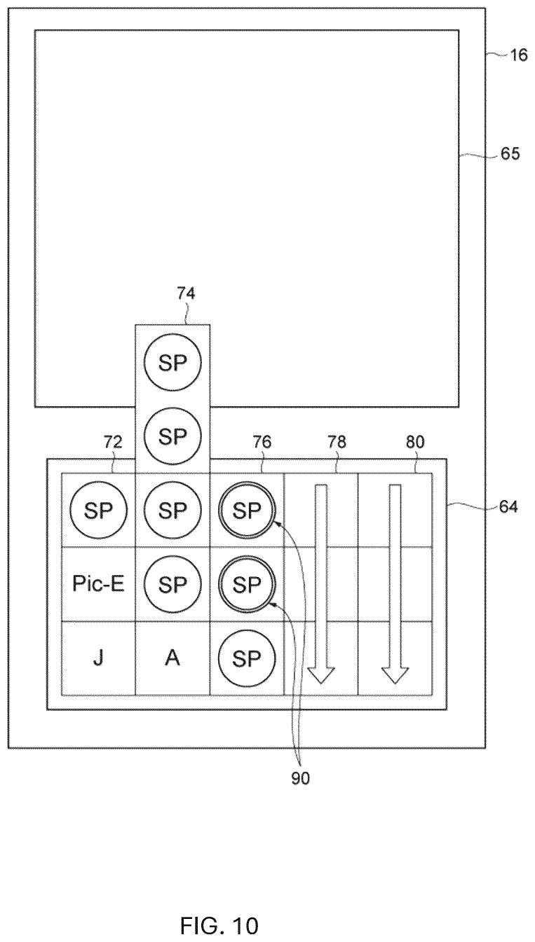

Then, the control unit 22 stops the spinning third reel (virtual reel strip 76), as shown in FIG. 9. In the example shown in FIG. 9, a special symbol 85 is displayed in the third column. Adjacent special symbols 85 are displayed in the first and second columns of the display area on the display 16 by the previously stopped first and second reels and in the third column of the display area on the display 16 by the newly stopped third reel. Here, the special symbols 85 make up a winning combination, so the feature function is triggered again. For example, as shown in FIG. 10, the control unit 22 determines that the number of special symbols 85 to be added will be two, for example, by drawing lots using random numbers. The control unit 22 then displays two additional special symbols 85 (additional symbols 90) above the special symbol 85 displayed in the third column before stopping the fourth reel. Thus, the feature function in the present embodiment can be triggered by a preceding reel to add a special symbol to the preceding reel, and then on a succeeding reel to add a special symbol to the succeeding reel. Since the reels that are added to both the preceding and succeeding reels are special symbols that form winning combinations, high payout wins are more likely to occur and the anticipated value is higher.

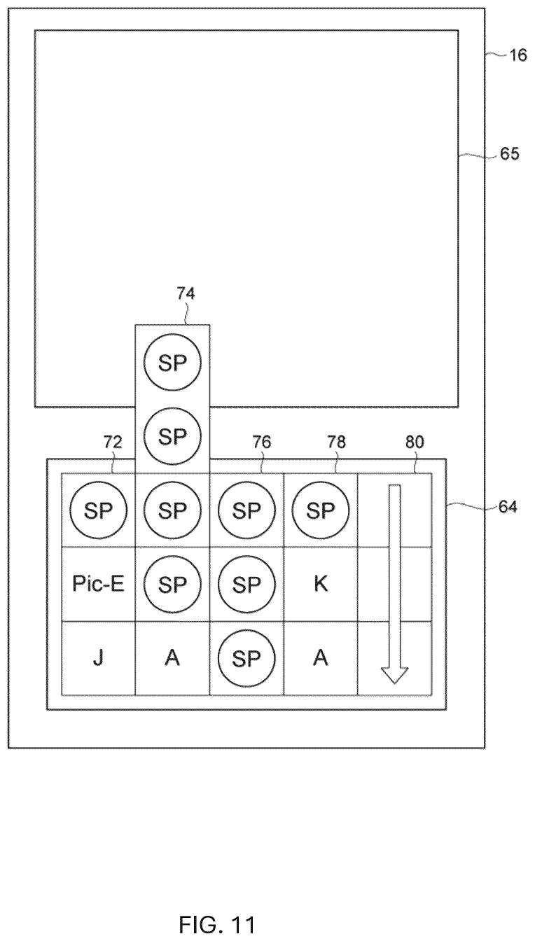

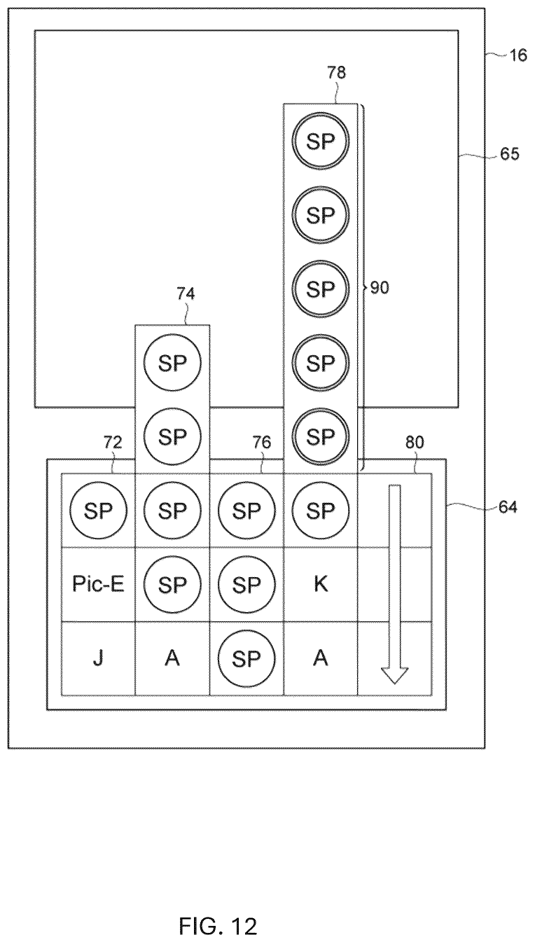

Then, the control unit 22, as shown in FIG. 11, stops the spinning fourth reel (virtual reel strip 78). In the example shown in FIG. 11, a special symbol 85 is displayed in the fourth column. Adjacent special symbols 85 are displayed in the third column of the display area on the display 16 by the previously stopped third reel and the fourth column of the display area on the display 16 by the newly stopped fourth reel. Here, the special symbols 85 make up a winning combination, so the feature function is triggered again. For example, as shown in FIG. 12, the control unit 22 determines that the number of special symbols 85 to be added will be five, for example, by drawing lots using random numbers. The control unit 22 then displays five additional special symbols 85 (additional symbols 90) above the special symbol 85 displayed in the fourth column before stopping the fifth reel.

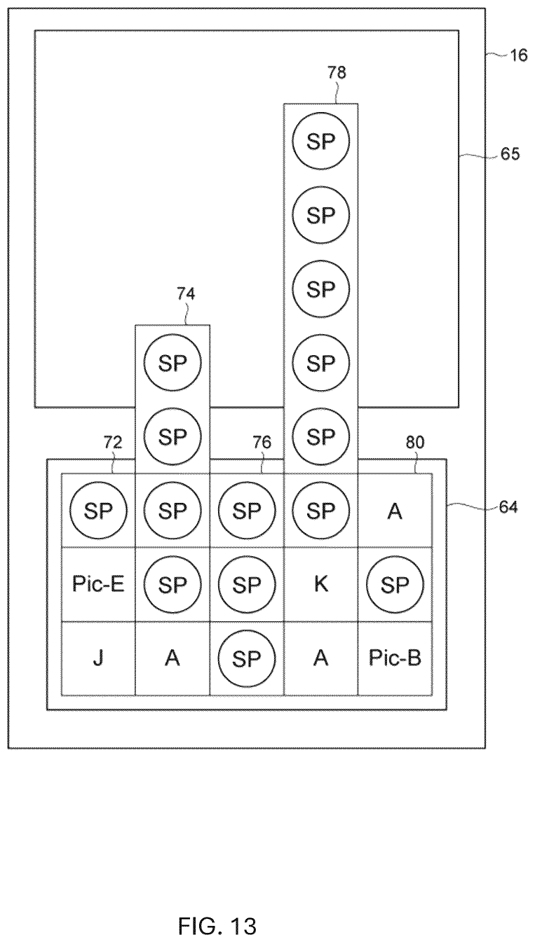

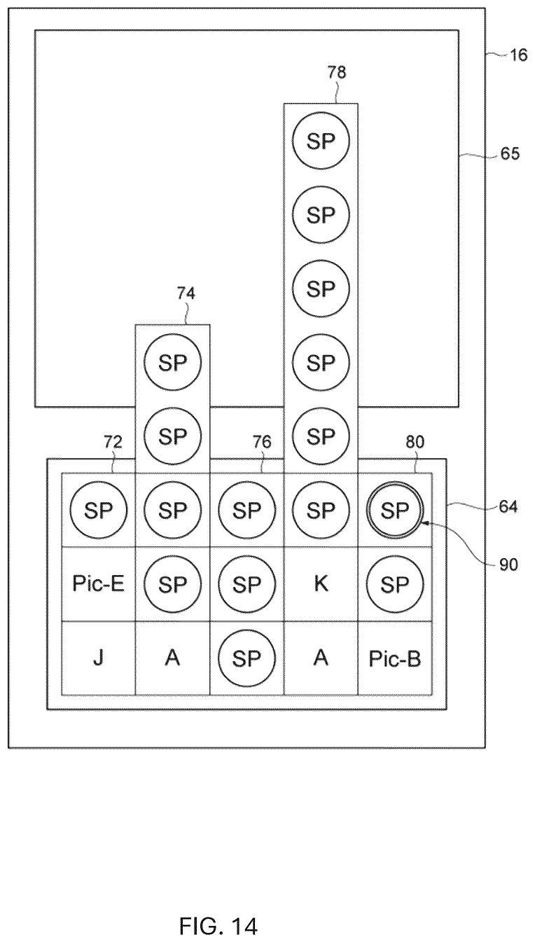

Then, the control unit 22, as shown in FIG. 13, stops the spinning fifth reel (virtual reel strip 78). In the example shown in FIG. 13, a special symbol 85 is displayed in the fifth column formed by the fifth reel in the symbol display area 64. Adjacent special symbols 85 are displayed in the fourth column of the display area on the display 16 by the previously stopped fourth reel and the fifth column of the display area on the display 16 by the newly stopped fifth reel. Here, the special symbols 85 make up a winning combination, so the feature function is triggered again. For example, as shown in FIG. 14, the control unit 22 determines that the number of special symbols 85 to be added will be one, for example, by drawing lots using random numbers. The control unit 22 then displays one additional special symbol 85 (additional symbol 90) above the special symbol 85 displayed in the fifth column.

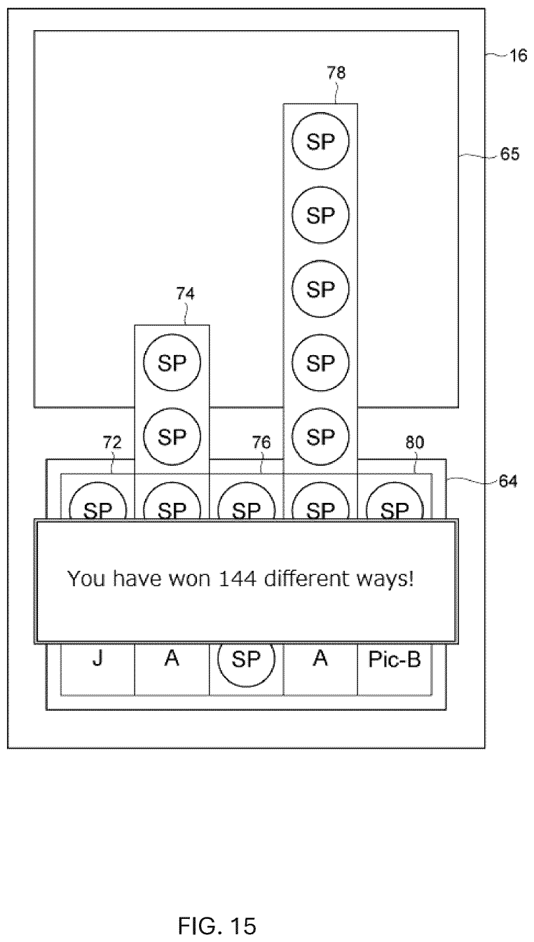

The control unit 22 determines the winning symbol combinations, including the additional symbols 90. In the example shown in FIG. 15, 144 different winning prizes (1×4×3×6×2) are won in the all-ways-win method and are displayed on the display 16. Therefore, in the present embodiment, the addition of special symbols by the feature function, together with the determination of winnings using the all-ways-win method, allows players to intuitively grasp that the feature function increases their total winnings. The player then expects hopes that a special symbol stops each time a reel stops, and expects more special symbols to be added when more special symbols stop. This helps to sustain or increase player interest.

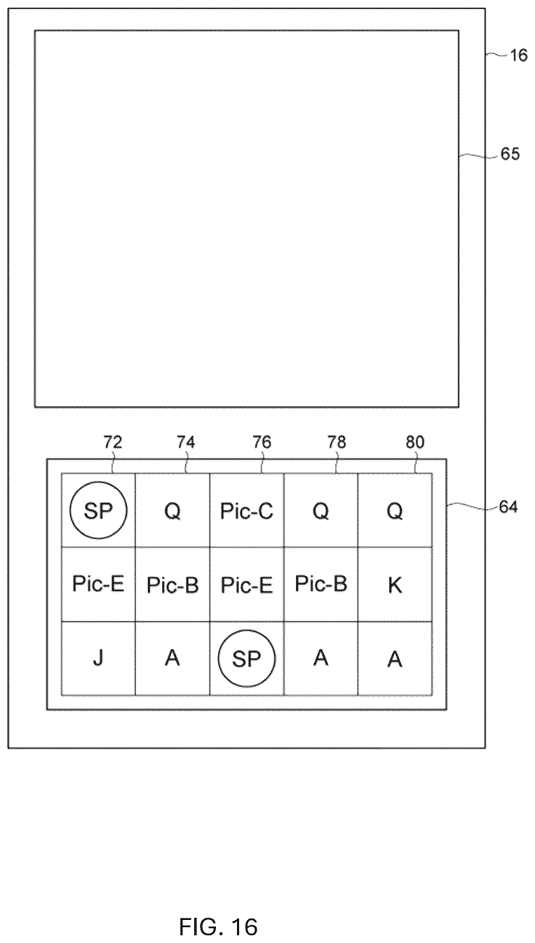

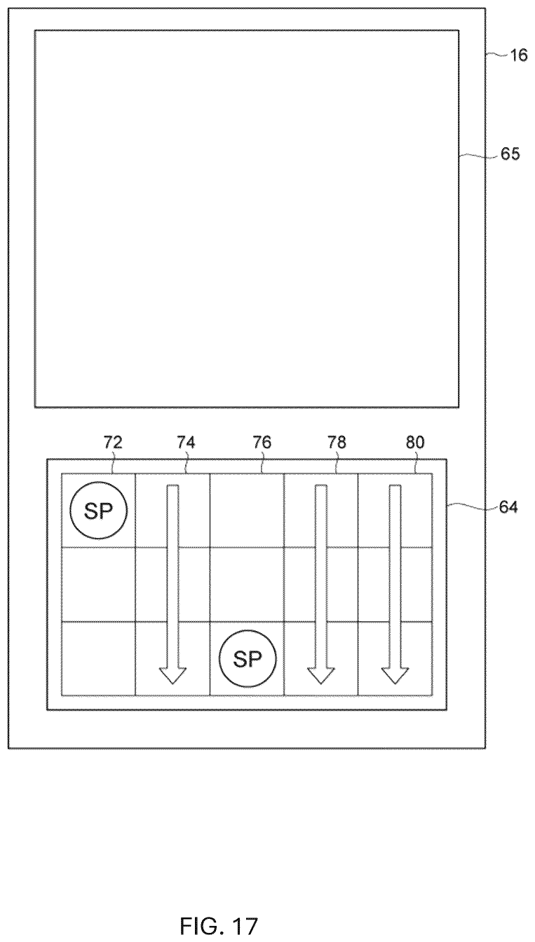

After all the reels have stopped, the control unit 22 may re-spin reels if predetermined conditions have been met. For example, the control unit 22 may re-spin reels when two conditions have been met: the arrangement of symbols displayed after all reels have stopped contains a certain number of special symbols 85 within a predetermined range, and there are reels related to columns that do not display a special symbol 85. Here, the reels subject to re-spinning are those related to columns that do not display a special symbol 85. For example, the number of special symbols 85 that qualify for re-spinning may be set to between two and five. In the example shown in FIG. 16, the arrangement of symbols displayed after all reels have stopped includes two special symbols 85, and the second, fourth and fifth reels do not display special symbols 85. In this case, the control unit 22 re-spins the second, fourth, and fifth reels as shown in FIG. 17.

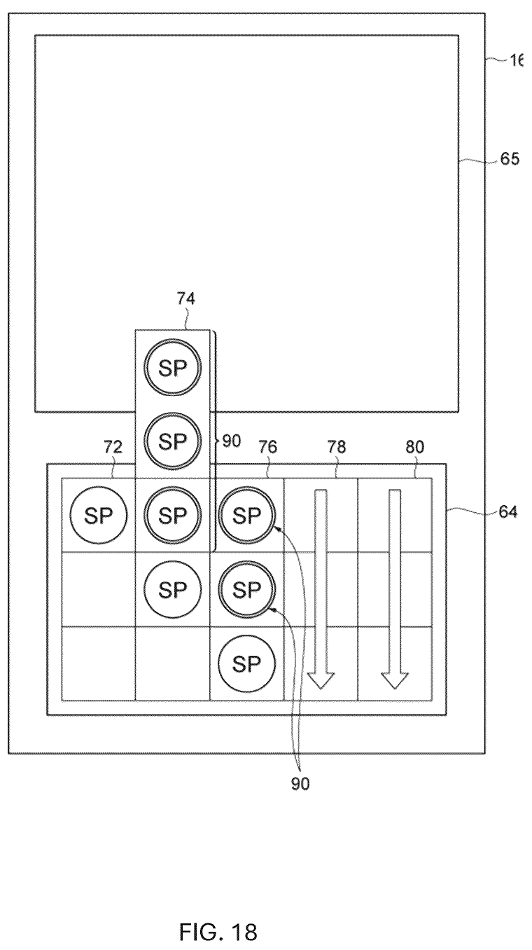

The control unit 22 then stops the second reel, as shown in FIG. 18. Adjacent special symbols 85 are displayed in the first column of the display area on the display 16 by the previously stopped first reel and the second column of the display area on the display 16 by the newly stopped second reel. Similarly, adjacent special symbols 85 are displayed in the third column of the display area on the display 16 by the previously stopped third reel and the second column of the display area on the display 16 by the newly stopped second reel. These special symbols 85 constitute winning combinations and thus trigger the feature function. For example, as shown in FIG. 18, the control unit 22 determines that the number of special symbols 85 to be added to the second will be three and that the number of special symbols 85 to be added to the third column will be two, for example, by drawing lots using random numbers. The control unit 22 then displays three additional special symbols 85 (additional symbols 90) above the special symbol 85 displayed in the second column before stopping the fourth reel. Similarly, the control unit 22 displays two additional special symbols 85 (additional symbols 90) above the special symbol 85 displayed in the third column before stopping the fourth reel.

For the fourth and fifth reels, special symbols 85 may be added in the manner shown in FIG. 11 to FIG. 14. By preparing for an event to re-spin the reels in this way, the player feels the disappointment of not winning a prize and then gets another chance to win a prize, thus further increasing the sense of anticipation.

The control unit 22 does not have to display additional special symbols 85 for the last reel to stop (for example, the fifth reel). Because the first reel is not among these reels, special symbols 85 are not added to the first reel. Therefore, in this case, special symbols 85 are added to the second, third, and fourth reels.

The control unit 22 may set an upper limit on the number of special symbols 85 that can be added. This avoids the addition of special symbols 85 beyond the display area of the display 16.

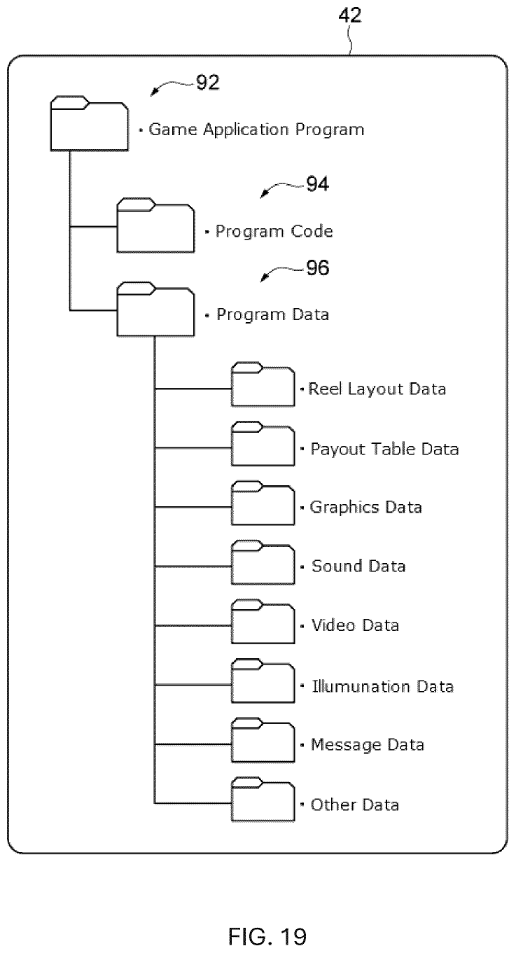

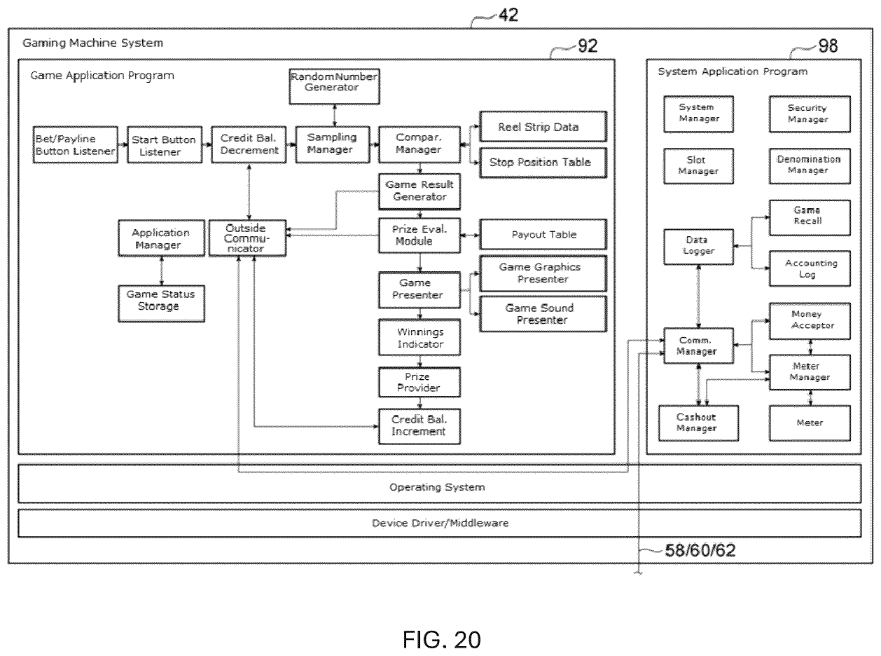

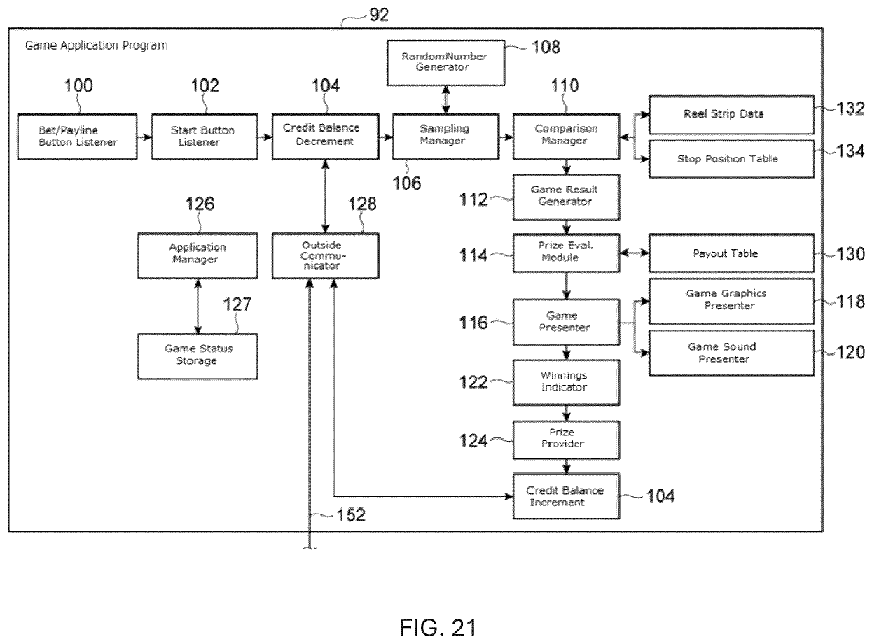

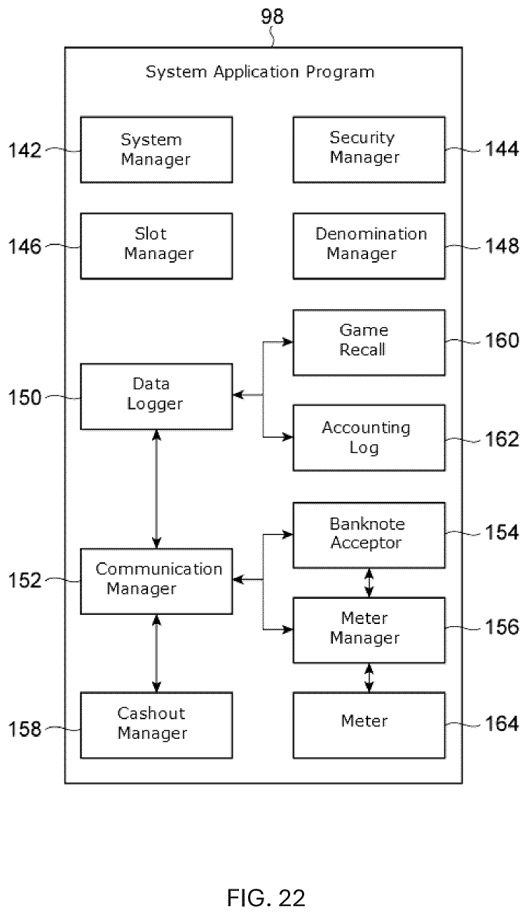

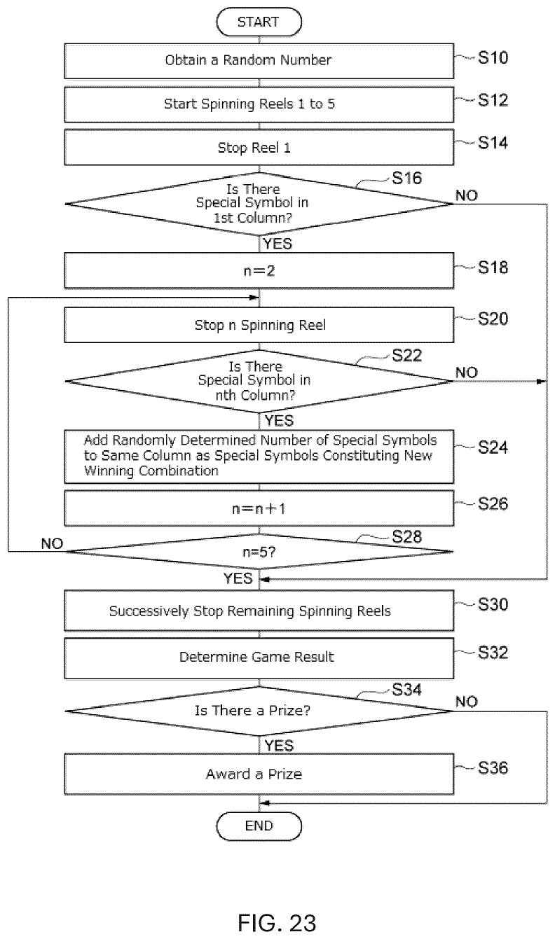

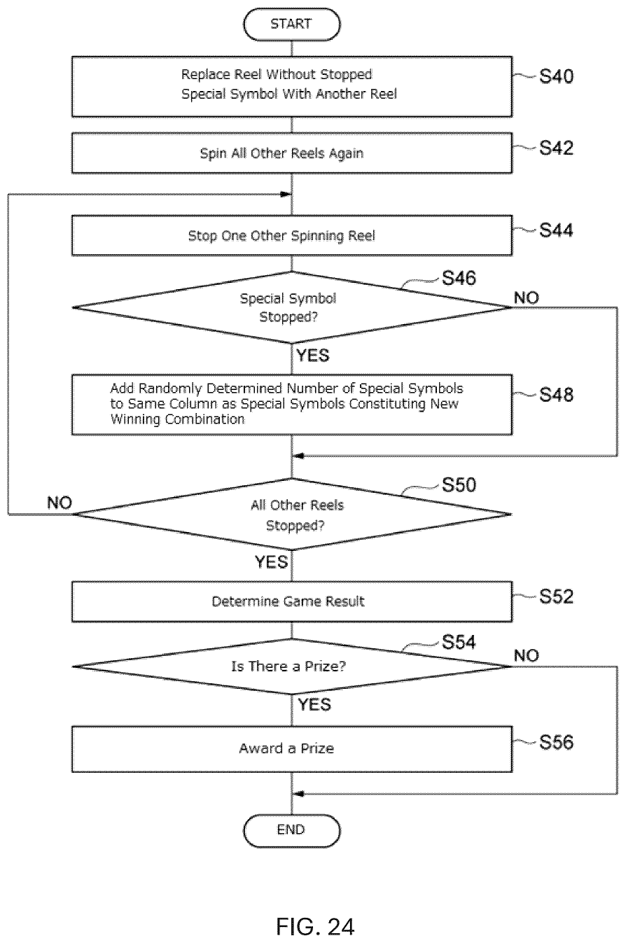

FIG. 19 and FIG. 20 are a directory diagram and block diagram showing the programs and data stored in the memory of FIG. 2. FIG. 21 is a block diagram of the game application program in FIG. 20. FIG. 22 is a block diagram of the system application program in FIG. 20. In the embodiment shown in FIG. 19 to FIG. 22, the memory 42 stores a game application program 92 containing computer-executable instructions, and these computer-executable instructions are executed by the CPU 38 to run the game on the game screen of the display 16 in the gaming machine 10. In one embodiment, the game application program 92 includes program code 94 and program object data 96 containing computer executable instructions for executing a game using the algorithms shown in FIG. 23 and FIG. 24.

In another embodiment, the memory 42 stores a game application program 92 and system application program 98 containing computer executable instructions, and the CPU 38 executes these computer executable instructions to display the game on the game screen of the display 16 in the gaming machine 10. The game application program 92 provides game-specific front-end functionality, while the system application program 98 provides generic back-end functionality when executed by the CPU. In the depicted example, the game application program 92 and the system application program 98 are run on the same operating system. However, these programs may be implemented on different operating systems or on different processors.

In one embodiment, the game application program 92 includes a plurality of software modules, including a bet/pay line button listener module 100, a start button listener module 102, a credit balance manager module 104, a sampling manager 106, a random number generator (RNG) 108, a comparison manager 110, a game result generator 112, a prize evaluating module 114, a game presenter 116, a game graphics presenter 118, a game sound presenter 120, winnings indicator 122, a prize provider 124, an application manager 126, and an outside communicator 128. The game application program 92 can include a payout table 130 (payout table), reel strip data 132, and a stop position table 134.

The bet/pay line button listener module 100 is a software module for accepting signals from bet buttons in the controls 32. These signals are generated by the buttons when the player operates the buttons to select a bet amount. In response to a received signal, the bet/pay line button listener module 100 communicates which signal has been generated to the application manager 126 in order to change the game bet.

The start button listener module 102 is a software module for accepting signals from the start button. These signals are generated when the player operates this button to start a game. In response to a received signal, the start button listener module 102 communicates that a signal has been generated to the application manager 126 to start the game.

When a signal has been received from the start button listener module 102, the application manager 126 has the sampling manager 106 obtain the required number of random numbers from the random number generator 108.

The random number generator 108 is a software module that generates random numbers based on a predetermined random number generation calculation algorithm. The random number generator 108 may be configured to generate pseudo-random numbers. The random number generator 108 returns random numbers in response to a request from the sampling manager 106. The random number generator 108 may be implemented in whole or in part as an integrated circuit or wired logic.

The comparison manager 110 compares the current state of the game and/or each random number with the reel strip data 132 and the stop position table 134 to specify the corresponding reel strip stop position based on each random number.

The reel strip data 132 has virtual reel strips for regular games, free games, and special games. The comparison manager 110 queries the application manager 126 to identify the current state of the game and select virtual reel strips.

The stop position table 134 contains a range of random numbers associated with each stop position for the virtual reel strips. The comparison manager 110 determines the stop position of each reel based on the corresponding random number and the stop position table 134.

The game result generator 112 generates game results based on the selected reel layout, the stop position of each reel, the stop position of the symbols on the reels, and any additional attributes. In one embodiment, the game result generator 112 may apply changes to game results when predetermined conditions are met.

The prize evaluation module 114 evaluates the game results by referring to the payout table 130. Specifically, prize evaluations are based on whether the symbols defined as winning combinations in the payout table 130 have stopped in the symbol display area.

The game presenter 116 uses the game graphics presenter 118 and the game sound presenter 120 to provide a game presentation process consisting of video and sound to eventually shape a given game outcome.

The game sound presenter 120 uses the sound controller 53 and speakers 26 to provide the sound presentation process. The winnings indicator 122 shows the winning combinations of winning symbols formed in the game results as well as the payout conditions. The prize provider 124 provides credits to a winnings meter based on the winnings evaluation.

The application manager 126 manages the operations and status of each software module. In addition, the application manager 126 manages the configuration, progress, and status of the game application program 92. The application manager 126 references a game status memory 127 to determine the size of the symbol display area 64 based on the stored game status in order to provide the game. The external communicator 128 exchanges instructions and data with the system application program 98.

The credit balance manager module 104 executes the process for decrementing the credit balance based on the bet amount and incrementing the credit balance based on the total amount of winnings displayed on the winnings meter. The payout table 130 includes the payout or awarded amount associated with each winning combination.

In one embodiment, the system application program 98 provides functions other than background processing and game-specific functions. The system application program 98 includes a system manager 142, a security manager 144, a slot management module 146, a denomination manager 148, a data logger 150, a communications manager 152, a banknote acceptor manager 154, a meter management module 156, and a cash-out manager 158.

The system application program 98 may include game recall file 160, an accounting log 162, and meters 164. The system manager 142 is a software module for managing all functions other than background processing and game-specific functions performed by the system application program 98.

The security manager 144 is a software module for managing game verification, door security, and monitoring security sensors. The slot management module 146 is a software module for managing data storage and communicating with external slot information systems.

The denomination manager 148 is a software module for configuring the denomination settings of the gaming machine 10. Denomination settings can include 1 cent, 2 cents, 5 cents, 25 cents, 1 dollar, 5 dollars, etc. The data logger 150 is a software module for recording the results of each game in the game recall. In addition, the data logger 150 stores error events, banknote logs, cash-out logs, and ticket logs in the accounting log.

A game recall file 160 is stored data containing the results of each game. The game recall file 160 is stored in nonvolatile memory. The accounting log 162 is stored data that includes error events, banknote logs, cash-out logs, and ticket logs, etc. The accounting log 162 is stored in nonvolatile memory.

The communication manager 152 is a software module that manages communication between the game application program 92 and the system application program 98. The communication manager 152 manages network communications between the system application program 98 and other gaming machines 10, and external networks (such as slot management system networks, G2S networks, gaming servers for server-based gaming networks, and VLT system networks).

The banknote acceptor manager 154 is a software module for managing a banknote acceptor and accepts information on banknotes inserted into the acceptor. In response to information received from the banknote acceptor, the banknote acceptor manager 154 communicates with the meter management module to increment the credit balance based on the inserted bill.

The meter management module 156 is a software module for adjusting the value of the meters 164 in response to communication with the game application program 92 via the communication manager 152, banknote acceptor manager 154, or cash-out manager 158. The meters 164 includes a credit meter that indicates the current credit balance on the gaming machine and a winnings meter that indicates the total amount of winnings in the current gaming session. The meter also includes background meters, such coin-in, coin-out, total drop, jackpots paid by the customer service staff, and/or paper money meters. These meters may be implemented as data on nonvolatile memory or as hardware meters.

The cash-out manager 158 is a software module for managing the cash-out procedure. The cash-out manager 158 is activated in response to the player operating the cash-out button, and the gaming machine pays out the total on the credit meter in the form of cash or vouchers.

FIG. 23 and FIG. 24 are flowcharts illustrating the algorithms used for operations performed by the gaming machine. The algorithms for operating the gaming machine (the gaming method) are implemented in the game application program 92 and are realized by the CPU 38 executing the game application program 92 to generate and display the animated sequences of computer-generated images illustrated in FIGS. 6-18 on graphic user interface screens of the gaming machine 10 to display the game to the player. The operations performed by the gaming machine include a plurality of steps. Each step may be performed independently or in combination with other steps.

In step S10, when the control unit 22 accepts a game start operation from a player and a spin button operation from the player, it deducts the set total bet amount from the player credit and obtains a predetermined number of random numbers required to provide the game. Random numbers are generated internally by the random number generator 108 in the control unit 22. The control unit 22 may be configured to obtain random numbers from a random number generator installed separately from the control unit 22, or from a server or other device installed outside the gaming machine 10.

In step S12, the control unit 22 starts spinning the reels. In the following description, the first reel is referred to as reel 1, the second reel as reel 2, the third reel as reel 3, the fourth reel as reel 4, and the fifth reel as reel 5. The reels are identified using variable n (which is a natural number with the initial value being 1).

In step S14, the control unit 22 stops reel 1. As a result, the first column is displayed in the symbol display area 64. In step S16, the control unit 22 determines whether a special symbol 85 has stopped and is being displayed in the first column. If a special symbol 85 has stopped and is being displayed in the first column (step S16: YES), the control unit 22 assigns 2 to variable n in step S18. The control unit 22 then stops reel n (n=2) in step S20. Next, the control unit 22 determines, in step S22, whether a special symbol 85 has stopped and is being displayed in the nth column (n=2).

If a special symbol 85 has stopped and is being displayed in the nth column (n=2) (step S22: YES), it constitutes a new winning combination. In step S24, the control unit 22 adds a randomly determined number of special symbols 85 to the same column as special symbol 85 making up the new winning combination (shown in FIGS. 6-15). The control unit 22 then increments variable n by 1 in step S26. This results in n=3. The control unit 22 then determines whether n=5 in step S28.

If it is determined that n=5 is not true (step S28: NO), the control unit 22 returns to step S20 and repeats the process up to step S28 with n=3.

If no special symbol 85 has stopped and is being displayed in the first column (step S16: NO), no special symbol 85 has stopped and is being displayed in the nth column (step S22: NO) and n=5 is determined to be true (step S28: YES), the control unit 22 performs step S30 to sequentially stop the remaining spinning reels.

The control unit 22 verifies the combination of symbols as the game result in step S32, and determines whether the combination of symbols is a winning combination in step S34. If it is determined that winnings have been won (step S34: YES), the control unit 22 awards the amount corresponding to the winnings as a prize in step S36. For example, the control unit 22 adds the amount corresponding to the prize to the credits held. If it has been determined that no winnings have been won (step S34: NO), no prize is awarded and the flowchart shown in FIG. 23 ends.

Next, the re-spin feature function will be described. The flowchart shown in FIG. 24 is executed after the flowchart shown in FIG. 23 has been completed when the conditions for the start of a re-spin have been met (shown in FIGS. 16-18). The two conditions for the start of a re-spins are that the arrangement of symbols displayed after all reels have been stopped contains a number of special symbols 85 within a predetermined range, and that there are reels related to columns that are not displaying a special symbol 85.

First, in step S40, the control unit 22 replaces a reel on which a special symbol 85 has not stopped with another reel. For example, a separate reel is a grayed-out version of a virtual reel strip shown in FIG. 4 with symbols other special symbols 85. The grayed-out symbols do not make up a winning combination. In other words, after the re-spin, only the winnings with special symbols 85 are determined.

The control unit 22 then starts spinning all the separate reels in step S42. The control unit 22 stops one of the spinning separate reels in step S44. The control unit 22, for example, stops the leftmost separate reel that is spinning. This causes a column corresponding to the separate reel to appear in the symbol display area 64. In step S46, the control unit 22 determines whether a special symbol 85 has stopped and is being displayed in the column corresponding to the separate reel. When a special symbol 85 has stopped and is being displayed in the column corresponding to the separate reel (step S46: YES), the control unit 22 adds a randomly determined number of special symbols 85 to the same column as a special symbol 85 that makes up a new winning combination in step S48.

If a special symbol 85 has been added (step S48) or if a special symbol 85 has not stopped and is not being displayed in the column corresponding to the separate reel (step S46: NO), the control unit 22 determines whether all the separate reels have been stopped in step S50.

If it has been determined that all the separate reels have not been stopped (step S50: NO), the control unit 22 moves to step S44 and repeats the process from step S44 to step S50. If it has been determined that all the separate reels have been stopped (step S50: YES), the control unit 22 determines the combination of symbol for the game result in step S52 and determines whether the combination of symbols is a winning combination in step S54. As noted above, the presence or absence of a winning combination of special symbols 85 is determined after the re-spin. If it is determined that a prize has been won (step S54: YES), the control unit 22 grants the amount corresponding to the prize as winnings in step S56. For example, the control unit 22 adds the amount corresponding to the prize to the credits held. If it has been determined that no prize has been awarded (step S54: NO), no prize is awarded and the flowchart shown in FIG. 24 ends.

When adjacent special symbols 85 appear in a column formed in the display area by a previously stopped reel and a column formed in the display area by a newly stopped reel, in gaming the machine 10, a randomly determined number of special symbols 85 are added to the column formed in the display area by the newly stopped reel before the next reel has been stopped. By offering a chance to increase the number of special symbols 85 on a reel by reel basis, the gaming machine 10 gives players the opportunity to hope that a special symbol 85 will appear on every reel. Thus, the gaming machine 10 can provide a new and exciting twist that sustains or increases player interest.

The gaming machine 10 may be a client computing device, in which case the game is delivered from a network server computer system to one or more client computing devices via a communications network. Here, the processor in the client computing device can be programmed to function as the control unit 22 of the gaming machine 10.

When the gaming machine 10 is a client computing device, it can be used as part of 1) a rich client system in which the client performs most of the processing involved in game execution and sends the results to the server, 2) a thin client system in which only minimal processing is done on the client side and the main processing is done on the server side, or 3) a zero client system in which the server does most of the data storage and processing and the client specializes in input and output.

In the embodiments described above, each column of cells in the grid 68 is associated with a virtual reel strip 72-80, but it is also possible to associate an independent reel with each of the cells. In this case, a reel is stopped for each of the reels that form a column, and the feature function may be activated when a newly stopped special symbol forms a winning combination.

The method used to determine prize winnings in the embodiments described above was the all-ways-win method, but the present invention is not limited to this method. For example, the pay line method can be used which sets pay lines on the display screen, or the scatter method which simply determines the number of symbols displayed regardless of position. In addition, the embodiments described above use a feature function that is triggered when a winning combination has been created, but the present invention is not limited to this example. For example, the feature function may be triggered when a winning combination is possible. In this case, while it is not possible to completely eliminate situations in which the feature function is triggered but no prize is awarded, a feature function can be realized that has a higher possibility of awarding prizes than conventional machines. In addition, there may be more than one type of special symbol 85. In this case, special symbols of a type that satisfies certain conditions may be added to the feature function.

The functions of the control unit 22 of the gaming machine 10 described above can also be realized by a computer executing a program. In other words, a program can be created to make one or more computers function in the same way as the control unit 22 described above. The program can, for example, be recorded and provided on a computer-readable recording medium, such as ROM or semiconductor memory. The program may also be divided into multiple modules.

Variations on the operations in the embodiment described above are also possible. For example, the reel stop positions can be determined by obtaining a necessary number of random numbers in advance, and special game winners and prize winners can be determined and then displayed sequentially on the display. Also, the control unit 22 may obtain the required number of random numbers in a batch at the start of a game and store the random numbers in the memory area of the memory 42 or storage 44 that is not erased in the event of a power failure. In this way, if a power failure occurs during a game, the control unit 22 can reproduce the progress of the game by retrieving the random numbers obtained at the start of the game before the power failure from the memory 42 or storage 44 once the game is restarted after power is restored. For example, if a power failure occurs just before a game result with a high payout ends, there could be a problem if the same game cannot be resumed after power is restored. The problem can be avoided by acquiring all random numbers at the start of the game as described above and saving the random numbers in the memory 42 or storage 44, so that after power is restored, the game progress can be resumed as it was before the power failure occurred.

In the embodiments described above, banknotes or tickets are used to indicate the game value, banknotes or tickets are accepted by a banknote/ticket identifying device, and a ticket is outputted by a printer unit. However, the concept of game value includes tangible objects such as coins, paper money, coins, medals, and tickets, as well as electronic data such as virtual credits and virtual currency of equivalent value. For example, a coin acceptor can accept coins and pay out coins from a coin hopper. Also, a system may be designed to identify players and credits accumulated in an account on a server, and pay out credits to the account. The system may read credit information recorded on a magnetic card, IC card, or other storage medium, and pay out credits by writing them to the storage medium. In addition, credit may be transferred electronically to and from a smartphone or wearable device.

The present disclosure includes the following items:

A gaming machine comprising: a control panel that accepts player operations; a display unit having a display area that partially displays a plurality of reels each having symbols, the symbols including special symbols; and a control unit connected to the control panel and the display unit that spins and stops the plurality of reels in response to the player operating the control panel, and awards a prize when the displayed symbols form a winning combination over a predetermined number of columns of symbols among the stopped reels in the display area, wherein the control unit sequentially stops the reels after spinning of the reels has been started, adds, when special symbols displayed in a column formed by a reel that has already stopped and a column formed by a newly stopped reel in the display area form a winning combination, a randomly determined number of special symbols is added to the column formed by the newly stopped reel in the display area before stopping the next reel, and awards a prize for the arrangement of the special symbols displayed after all the reels have been stopped.

The gaming machine, wherein the winning combination is made up of identical symbols that appear in a plurality of columns that are consecutive from one end of the display area, and the control unit sequentially stops the reels in order from the reel at the one end of the column.

The gaming machine, wherein the control unit adds and displays a special symbol above a special symbol displayed on the newly stopped reel.

The gaming machine, wherein the control unit does not add and display a special symbol for a special symbol displayed on the reel that is stopped last.

The gaming machine, wherein the control unit, when the arrangement of symbols displayed after all the reels have been stopped includes a predetermined number of special symbols and there is a column that does not display the special symbol, re-spins and stops the reel related to the column, and when the stopped reel newly displays the special symbol in the column and forms a winning combination with the special symbols that appear on the reels that have already been stopped, adds and displays a randomly determined number of special symbols is added to the column that has the special symbols forming a new winning combination, and awards a prize for the arrangement of special symbols displayed after all the reels have been stopped.

A method for providing a game executed by a gaming machine comprising: a control panel that accepts player operations; a display unit having a display area that partially displays a plurality of reels each having symbols, the symbols including special symbols; and a control unit connected to the control panel and the display unit that spins and stops the plurality of reels in response to the player operating the control panel, and awards a prize when the displayed symbols form a winning combination over a predetermined number of columns of symbols among the stopped reels in the display area, wherein the control unit executes the steps of: sequentially stopping the reels after spinning of the reels has been started; adding, when special symbols displayed in a column formed by a reel that has already stopped and a column formed by a newly stopped reel in the display area form a winning combination, a randomly determined number of special symbols is added to the column formed by the newly stopped reel in the display area before stopping the next reel; and awarding a prize for the arrangement of the special symbols displayed after all the reels have been stopped.

A program executed by a control unit in a gaming machine comprising: a control panel that accepts player operations; a display unit having a display area that partially displays a plurality of reels each having symbols, the symbols including special symbols; and a control unit connected to the control panel and the display unit that spins and stops the plurality of reels in response to the player operating the control panel, and awards a prize when the displayed symbols form a winning combination over a predetermined number of columns of symbols among the stopped reels in the display area, wherein the program executes in the control unit the functions of: sequentially stopping the reels after spinning of the reels has been started; adding, when special symbols displayed in a column formed by a reel that has already stopped and a column formed by a newly stopped reel in the display area form a winning combination, a randomly determined number of special symbols is added to the column formed by the newly stopped reel in the display area before stopping the next reel; and awarding a prize for the arrangement of the special symbols displayed after all the reels have been stopped.

### REFERENCE NUMBERS

10: Gaming machine
16: Display (example of display unit)
22: Control unit
32: Controls

What is claimed is:

1. A gaming machine comprising:
a control panel that accepts player operations;
a display unit including a display screen displaying computer-generated images thereon; and
a control unit operably coupled to the control panel and the display unit, the control unit including one or more processors programmed to execute an algorithm to display an animated sequence of computer-generated images on the display unit including the steps of:
displaying a display area on the display screen that partially displays a plurality of reels each having symbols, the symbols including special symbols;
spinning the plurality of reels in response to the player operating the control panel;
sequentially stopping the reels after spinning of the reels has been started; and
adding, when special symbols displayed in a column formed by a reel that has already stopped and a column formed by a newly stopped reel in the display area form a winning combination, a randomly determined number of additional special symbols to the column formed by the newly stopped reel in the display area before stopping the next reel.

2. The gaming machine of claim 1, wherein the one or more processors is programmed to execute the algorithm including the steps of:
determining the winning combination as identical symbols that appear in a plurality of columns that are consecutive from one end of the display area; and
sequentially stopping the reels in order from a first reel at the one end of the column.

3. The gaming machine of claim 2, wherein the one or more processors is programmed to execute the algorithm including the steps of:
displaying the randomly determined number of additional special symbols above a special symbol displayed on the newly stopped reel.

4. The gaming machine of claim 1, wherein the one or more processors is programmed to execute the algorithm including the steps of:
displaying the plurality of reels including five reels displayed within a plurality of cells arranged in a 3×5 grid;
stopping a first reel to display a first special symbol within a first column of the 3×5 grid;
stopping a second reel adjacent to the first reel to display a second special symbol within a second column of the 3×5 grid; and
adding the additional special symbols to the second reel by animating the additional special symbols to appear in cells above the second special symbol as a third reel, a fourth reel, and a fifth reel are spinning.

5. The gaming machine of claim 4, wherein the one or more processors is programmed to execute the algorithm including the steps of:
modifying the second column by increasing a number of corresponding cells displayed within the second column to extend the second column upward to display at least one additional special symbol above the 3×5 grid.

6. The gaming machine of claim 5, wherein the one or more processors is programmed to execute the algorithm including the steps of:
determining a number of symbol combinations including the displayed special symbols and displaying a notification message on the display screen displaying the determined number of symbol combinations.

7. The gaming machine of claim 1, wherein the one or more processors is programmed to execute the algorithm including the steps of:
displaying the plurality of reels including five reels displayed within a plurality of cells arranged in a grid;
stopping a first reel to display a first special symbol within a first column of the grid;
stopping a second reel adjacent to the first reel to display the second reel without a special symbol within a second column;
stopping a third reel adjacent to the second reel to display another special symbol within a third column of the grid;
re-spinning and stopping the second reel to display a second special symbol within the second column; and
adding the additional special symbols to the second reel by:
animating the additional special symbols to appear in cells above the second special symbol as a fourth reel, and a fifth reel are spinning; and
modifying the second column by increasing a number of corresponding cells displayed within the second column to extend the second column upward to display at least one additional special symbol above the grid.

8. A method of operating a gaming machine including a control panel that accepts player operations, a display unit including a display screen displaying computer-generated images thereon, and a control unit including one or more processors operably coupled to the control panel and the display unit, the method including the one or more processors performing an algorithm to display an animated sequence of computer-generated images on the display screen including the steps of:
displaying a display area on the display screen that partially displays a plurality of reels each having symbols, the symbols including special symbols;
spinning the plurality of reels in response to the player operating the control panel;
sequentially stopping the reels after spinning of the reels has been started; and
adding, when special symbols displayed in a column formed by a reel that has already stopped and a column formed by a newly stopped reel in the display area form a winning combination, a randomly determined number of additional special symbols to the column formed by the newly stopped reel in the display area before stopping the next reel.

9. The method of claim 8, including the one or more processors performing the algorithm including the steps of:
determining the winning combination as identical symbols that appear in a plurality of columns that are consecutive from one end of the display area; and
sequentially stopping the reels in order from a first reel at the one end of the column.

10. The method of claim 9, including the one or more processors performing the algorithm including the steps of:
displaying the randomly determined number of additional special symbols above a special symbol displayed on the newly stopped reel.

11. The method of claim 8, including the one or more processors performing the algorithm including the steps of:
displaying the plurality of reels including five reels displayed within a plurality of cells arranged in a 3×5 grid;
stopping a first reel to display a first special symbol within a first column of the 3×5 grid;
stopping a second reel adjacent to the first reel to display a second special symbol within a second column of the 3×5 grid; and
adding the additional special symbols to the second reel by animating the additional special symbols to appear in cells above the second special symbol as a third reel, a fourth reel, and a fifth reel are spinning.

12. The method of claim 11, including the one or more processors performing the algorithm including the steps of:
modifying the second column by increasing a number of corresponding cells displayed within the second column to extend the second column upward to display at least one additional special symbol above the 3×5 grid.

13. The method of claim 12, including the one or more processors performing the algorithm including the steps of:
determining a number of symbol combinations including the displayed special symbols and displaying a notification message on the display screen displaying the determined number of symbol combinations.

14. The method of claim 8, including the one or more processors performing the algorithm including the steps of:
displaying the plurality of reels including five reels displayed within a plurality of cells arranged in a grid;
stopping a first reel to display a first special symbol within a first column of the grid;
stopping a second reel adjacent to the first reel to display the second reel without a special symbol within a second column;
stopping a third reel adjacent to the second reel to display another special symbol within a third column of the grid;
re-spinning and stopping the second reel to display a second special symbol within the second column; and
adding the additional special symbols to the second reel by:
animating the additional special symbols to appear in cells above the second special symbol as a fourth reel, and a fifth reel are spinning; and
modifying the second column by increasing a number of corresponding cells displayed within the second column to extend the second column upward to display at least one additional special symbol above the grid.

15. A non-transitory computer-readable storage media having computer-executable instructions embodied thereon to operate a gaming machine including a control panel that accepts player operations, a display unit including a display screen displaying computer-generated images thereon, and a control unit including one or more processors operably coupled to the control panel and the display unit, when executed by the one or more processors the computer-executable instructions cause the one or more processors to perform an algorithm to render an animated sequence of computer-generated images on the display screen including the steps of:
displaying a display area on the display screen that partially displays a plurality of reels each having symbols, the symbols including special symbols;
spinning the plurality of reels in response to the player operating the control panel;
sequentially stopping the reels after spinning of the reels has been started; and
adding, when special symbols displayed in a column formed by a reel that has already stopped and a column formed by a newly stopped reel in the display area form a winning combination, a randomly determined number of additional special symbols to the column formed by the newly stopped reel in the display area before stopping the next reel.

16. The non-transitory computer-readable storage media of claim 15, wherein the computer-executable instructions cause the one or more processors to perform the algorithm including the steps of:
determining the winning combination as identical symbols that appear in a plurality of columns that are consecutive from one end of the display area; and
sequentially stopping the reels in order from a first reel at the one end of the column.

17. The non-transitory computer-readable storage media of claim 16, wherein the computer-executable instructions cause the one or more processors to perform the algorithm including the steps of:
displaying the randomly determined number of additional special symbols above a special symbol displayed on the newly stopped reel.

18. The non-transitory computer-readable storage media of claim 15, wherein the computer-executable instructions cause the one or more processors to perform the algorithm including the steps of:
displaying the plurality of reels including five reels displayed within a plurality of cells arranged in a 3×5 grid;
stopping a first reel to display a first special symbol within a first column of the 3×5 grid;
stopping a second reel adjacent to the first reel to display a second special symbol within a second column of the 3×5 grid; and
adding the additional special symbols to the second reel by animating the additional special symbols to appear in cells above the second special symbol as a third reel, a fourth reel, and a fifth reel are spinning.

19. The non-transitory computer-readable storage media of claim 18, wherein the computer-executable instructions cause the one or more processors to perform the algorithm including the steps of:
modifying the second column by increasing a number of corresponding cells displayed within the second column to extend the second column upward to display at least one additional special symbol above the 3×5 grid.

20. The non-transitory computer-readable storage media of claim 15, wherein the computer-executable instructions cause the one or more processors to perform the algorithm including the steps of:
displaying the plurality of reels including five reels displayed within a plurality of cells arranged in a grid;
stopping a first reel to display a first special symbol within a first column of the grid;
stopping a second reel adjacent to the first reel to display the second reel without a special symbol within a second column;
stopping a third reel adjacent to the second reel to display another special symbol within a third column of the grid;
re-spinning and stopping the second reel to display a second special symbol within the second column; and
adding the additional special symbols to the second reel by:
animating the additional special symbols to appear in cells above the second special symbol as a fourth reel, and a fifth reel are spinning; and
modifying the second column by increasing a number of corresponding cells displayed within the second column to extend the second column upward to display at least one additional special symbol above the grid.
